(19) United States
(12) Patent Application Publication
(10) Pub. No.: US 2007/0054245 A1
(43) Pub. Date: Mar. 8, 2007

(54) Behavior modification system

(75) Inventors: Marc Greenfield, Homestead, FL (US); Stephen Craft, Yorktown, VA (US)

Correspondence Address: HEDMAN & COSTIGAN P.C., 1185 AVENUE OF THE AMERICAS, NEW YORK, NY, 10036, US

(73) Assignee: Lateral Solutions, Inc.

(21) Appl. No.: 11/593,335

(22) Filed: Nov. 6, 2006

Related U.S. Application Data
(63) Continuation-in-part of application No. 11/098,140, filed on Apr. 4, 2005.
(60) Provisional application No. 60/561,120, filed on Apr. 8, 2004.

(51) Int. Cl. G09B 21/00

(52) U.S. Cl. 434/112

(57) ABSTRACT

The invention is directed to a system for reminding an inattentive child to return to an ongoing educational task. The system comprises a transmitter means that is adapted to transmit a signal to one or more individually tuned receivers that are adapted to be worn by a student, each of said receivers being adapted to receive said signal and in turn generate a further signal that activates a notification means that silently reminds the student to focus attention on the task at hand.

This application is a continuation in part of Ser. No. 11/098,140, filed Apr. 5, 2005 which claims the benefit of provisional application Ser. No. 60/561,120.

### BACKGROUND OF THE INVENTION

Inattentive children are sometimes classified as having Attention Deficit Hyperactivity Disorder (ADHD), Learning Disabilities and a number of mental disorders which cause them to be easily distracted from tasks that are assigned in a formal educational environment. Children who are consistently able to demonstrate proficiency on standardized tests have the ability to focus on classroom assignments without being distracted by the activities that are taking place in the area where they are reading or writing. Inattentive children with ADHD are easily distracted and sometimes require the intervention of a teacher in order to redirect their efforts at reading or writing in a classroom environment.

The teachers' intervention with ADHD and other inattentive students may mean the issuance of a verbal reminder directly to the inattentive student or in the case where the teacher chooses to avoid directing attention to the inattentive student may issue a general reminder to the class in situations where only one student is being inattentive. In either case, the issuance of verbal reminders poses a risk of embarrassment to the inattentive student as well as distracting other students.

A need exists for a system that can be silently directed to a particular student in a non-obtrusive manner that will not be detected by the other students but will direct the inattentive student's attention to the task at hand. In addition, the system is also capable of providing an unobtrusive reminder to a plurality of students who are working in the same or in a contiguous classroom space in an open classroom.

### SUMMARY OF THE INVENTION

The invention is a system for reminding an inattentive child to return to an ongoing educational task wherein the system comprises a transmitter means that is adapted to transmit a signal to one or more receivers adapted to be worn by a student; said receivers being adapted to receive said signal and in turn generate a further signal that activates a notification means that silently reminds the student to focus attention on the task at hand.

The system also preferably includes an automated counter that records the reminder signals sent to each student.

Accordingly it is a primary object of the invention to provide a method of reminding an inattentive child to resume a particular educational task in an unobtrusive manner.

It is also an object of this invention to provide a system that a teacher may use to silently remind an inattentive student to resume a given educational task.

It is also an object of this invention to provide a system that can selectively remind one or more inattentive students to resume a given educational task.

These and other objects of the invention will become apparent from the appended specification.

### BRIEF DESCRIPTION OF THE DRAWINGS

FIG. 1 is schematic diagram of the system of the invention showing how a signal is generated by a teacher and transmitted to a student.

FIG. 2 is drawing of a handheld device for use in transmitting signals from a teacher to a student according to the invention.

FIG. 3 is a schematic of an arrangement which shows the computer and monitor with a USB docking station that is adapted to engage the handheld device for programming.

FIG. 4 is a flow chart of the steps that may be used in the operation of the embodiment of the invention that uses Bluetooth technology.

FIG. 5 is a perspective view of a Bluetooth receiver that is adapted for attachment to the outside of the ear.

FIG. 6 is a perspective view of a Bluetooth receiver that is adapted to be fitted in the ear canal of a user.

### DETAILED DESCRIPTION OF THE INVENTION

The invention comprises a system that enables a teacher to selectively and silently remind an inattentive student to resume an interrupted educational task. The system or apparatus comprises a transmitter for sending one or a plurality of signals to one or a plurality of receivers that are capable of being worn on a students' person. The receiver is adapted to receive and generate a notification signal that makes a student aware that the teacher has noted that the student has been inattentive to an educational task. The signal that is generated by the receiver may be used to activate a notification means which comprises an inaudible vibrator and an audible sound generator. An inaudible vibrator is the preferred notification means because it is silent and reduces the potential for embarrassing the student by allowing other students to be aware of the inattentive student's inattention.

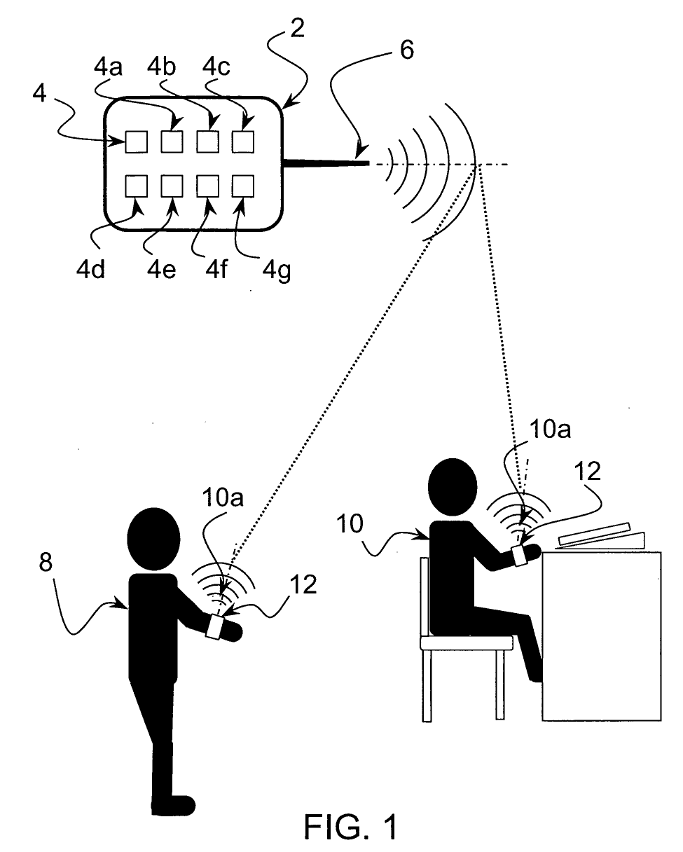

FIG. 1 is a schematic diagram of a system according to the present invention where transmitter 2 is provided with, for example keys 4,4a, 4b, 4c, 4d, 4e, 4f and 4g which are attached to individual frequency signal generating means that when actuated cause a signal to be emitted from antenna 6. Any number of keys may be utilized in conjunction with means for generating multiple transmitting frequencies. The receiver 12 will be tuned to a single frequency that is emitted by the transmitter 2. The receiver 12 is preferably a wrist mounted device having an appropriate antenna 10a. The receiver is adapted to vibrate at a frequency that will cause the student 8, 10 to become conscious that the teacher is sending a signal to remind the student to resume an educational task. The system is designed with battery powered receivers in order to allow the signal to reach a student 10 who is seated at a desk or a student 12 who is moving around the class room.

The system is designed to be used in connection with an orientation procedure where the student is apprised of the previously perceived periods of inattention that have been the basis for enlisting the students cooperation in wearing a receiver for receiving vibration inducing signals when the teacher activates the transmitter after detecting that the student has become inattentive to an educational task. The receiver may be attached to a wearer's by a wrist band or may be adapted to hang on the neck in the form of a decorative necklace.

The means for transmitting a signal may comprise a commercially available paging transmitter that is sold by Commtech which has a numeric keyboard that allows for signaling a plurality of receivers. The receiver may be a modified Commtech Patron Pager that vibrates in response to a signal and is adapted to be placed in a pocket or attached to a wrist as a simulated wrist watch. Infostream supplies a Scribe Desktop Paging Decoder that may be adapted to receive record and print out reports showing the frequency and number of signals that are sent to each student in a given group. Other systems that may be adapted for use in the invention are also commercially available. In the alternative, a customized system may be designed by one of ordinary skill in the art to facilitate the practice of the invention.

The system may also include an alternative counting apparatus that has a memory which records the number and frequency of the reminder signals that are sent to each individual student. An example of a counting apparatus is a numeric counter that records electrical impulses and has a display as well as a port for connection to a computer or printer for storing/printing out the recorded information. Alternatively, small counting devices with a display can be read and recorded by the teacher to be used for monitoring progress as well as for feedback to the students and their parents. The counting feature can be contained in a separate apparatus or integrated into the teachers' transmitter. These devices are commercially available such as the Commtech 6120, or they may be manufactured using conventional and well known designs.

The following alternative embodiment utilizes different means for transmitting signals between a teacher and the teachers students:

A teacher is provided with a small handheld device which combines a digital MP3 player (similar to the popular Apple iPod Nano 4G (Part Number: MA005LL/A) or the Rio Carbon, a simple digital audio recorder, a 1.3 megapixel digital camera (similar to those found in mobile phones like the Sony Ericsson k510a), an LCD screen and a Bluetooth wireless transmitter. The device provides a simple user interface designed around a scroll wheel, seven easy-click buttons and an on/off switch. It stores media on built-in digital flash memory. A directory of custom audio commands and pictures can be entered directly into the handheld device using the built in microphone and camera, or can be uploaded from a computer to the handheld device using a USB dock connector.

The handheld device is programmed with a unique set of recorded commands for each child who is provided with a receiver and optionally with their picture associated with their own folder in the directory. The teacher can easily select the proper student by scrolling to a specific students name with or without an associated picture and send the correct command with one hand using a scroll wheel (a simple rotational user input) and an enter button built into the scroll wheel on the handheld device.

The small handheld device measures approximately 3.00 inches tall, 1.50 inches wide, and 0.35 inches thick; so it easily fits in the palm of your hand. It uses a dock connector that can be plugged into a standard wall socket to charge the device. A USB cable connects the dock to the device to transfer data to and from a computer. (USB 2.0 standard has a maximum transfer speed of 480 Mbit/s) The device can play MP3, WAV, and AIFF, audio file formats. It is powered by rechargeable internal lithium-ion battery. The handheld device uses a small, compact microdrive or flash hard drive with a flash ROM chip containing a bootloader program. The program communicates to the device to load the operating system. A portion of the ROM chip is dedicated to the software operating system, which is loaded from the firmware, the other portion of the chip is used to cache audio files for efficient operation. The device can be used natively with both Mac OS and Windows because the hard drive is formatted with a FAT32 file system. The device also features a small 16-bit color LCD display screen capable of displaying many different colors, and the ability to store and display JPEG, BMP, GIF, TIFF, and PNG images.

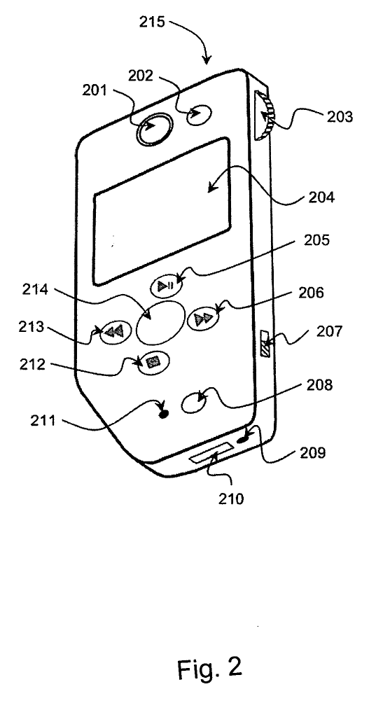

As best shown in FIG. 2, the handheld device has a digital camera 201, a photo button 202 to operate the digital camera, a scroll wheel and enter button 203, an LCD screen 204, a play-pause button 205, a forward button 206, a directory button 214, a stop button 212, a reverse button 213, a microphone 211, a record button 208, an on-off switch 207, a DC adapter input socket 209 to charge the battery (not shown), a USB docking connection port.

Handheld Device Operation:

The handheld device has seven buttons, a scroll wheel and an on/off switch:
1. A ‘Photo’ button which activates the camera and takes the students picture.
2. A partially embedded combination directory scroll wheel & ‘Enter’ button (which quickly scrolls forward and backward through the menu and selects or “enters” a menu item when depressed)
3. A ‘Play/Pause’ button which plays or pauses the track in play
4. A ‘Reverse’ button which skips back through the menu or tracks in play
5. A ‘Forward’ button which skips forward through the menu or tracks in play
6. A ‘Directory’ button which backs up one level in the directory or menu
7. A ‘Stop’ button which stops the play of the audio clips
8. A ‘Record’ button that activates the internal microphone and recorder
9. An ‘On/Off’ switch is located on the side of the device.

The handheld device would be similar in size to the Apple iPod Nano and is illustrated in FIG. 2.

The students each have either a small, discreet, almost completely unnoticeable ear bud electronic device that fits into the wearer's ear, similar to a traditional hearing aid or an over the ear receiver. Each ear bud is synchronized or paired to a specific Bluetooth frequency sequence which is associated with the individual directories for each student. The teacher maintains a unique directory that is broadcast on a unique frequency sequence from the handheld device for each student. When selected, the student hears the teacher's voice (or another appropriate voice) giving him or her positive, reinforcing direction to get focused and back on task.

These receivers may be constructed similar to hearing aids developed for children. This Bluetooth receiver has a small partially rounded case that fits behind the ear and transmits sound to the ear through an ear mold and a thin sound tube; a clear tube that runs down into the student's ear canal. On the inside of the ear canal there is a small soft silicone cone or a custom molded, highly vented acrylic tip that secures the tube in place. These are custom made to keep the ear canal as open as possible, so listeners can still utilize their natural hearing for the normal sounds created in the classroom environment. Smaller children will find this style especially useful because it is sturdy and large enough to easily incorporate the Bluetooth circuitry needed to connect to the classroom systems.

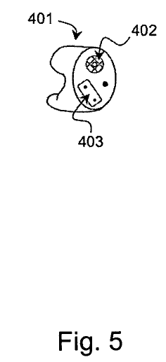

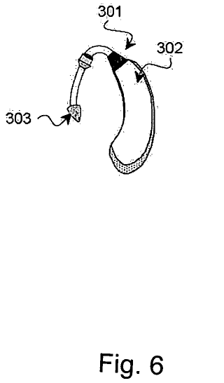

FIG. 5 is a perspective view of a Bluetooth receiver 401 that is adapted to fit in the ear. It is provided with a volume control 402 and a battery compartment 403. FIG. 6 is over-the-ear (OTE) Bluetooth receiver 301 having a receiver body 302 that contains the battery and the Bluetooth receiver and a soft silicone tip 303 that attached to the end of the sound tube which conducts sound to the ear from the receiver.

The tiny Bluetooth receivers may be made to fit mostly in the ear canal and usually will not be visible unless you look directly into the wearer's ear. This style is not recommended for young children because their fit cannot be as easily modified or customized after the original fitting. Consequently, the ear mold would then need to be replaced frequently as the child grows. As a child grows older, say 13-16 years old, he or she will probably be able to wear an in the ear device if it is appropriate for the situation because the inner ear geometry will not be changing as quickly.

The operation of this embodiment of the system is as follows: Once the proper command is selected by the teacher, the audio command is sent wirelessly, using Bluetooth technology (similar to that used for wireless headsets for mobile phones), to the student. A Bluetooth connection is wireless and basically automatic. Bluetooth is an inexpensive radio frequency network that uses very low transmission power (˜1 milliwatt) and eliminates the need for user intervention because it establishes a protocol level where different products agree on when bits are sent, how many bits are sent each time, and how the communicating devices can be sure that the message received is the same as the message sent. The new Bluetooth 2.0 standard can manage up to 3 megabits per second (Mbps).

Bluetooth networking communicates on a frequency of about 2.45 gigahertz (to be precise, it is between 2.402 GHz and 2.480 GHz). This frequency band has been set aside by an international agreement for the use of industrial, scientific and medical devices (ISM).

Because wireless Bluetooth technology uses low transmission power, it limits the range of a Bluetooth device to about 32 feet. Bluetooth can connect up to eight devices simultaneously. Even with all eight of those devices in the same 32-foot radius it is unlikely that they would interfere with one another. Bluetooth uses a technology called spread-spectrum frequency hopping that makes it rare for more than one device to be transmitting on the same frequency at the same time. In this technique, each device will use 79 individual, randomly chosen frequencies within a designated range, changing from one to another on a regular basis. For the Bluetooth wireless technology, the transmitters change frequencies 1,600 times per second. Because of this more devices can make full use of a limited portion of the radio spectrum. Since every Bluetooth transmitter uses spread-spectrum transmitting automatically, it's unlikely that two transmitters will be on the same frequency at the same time. This same technique minimizes the risk that portable phones or other wireless devices will disrupt other Bluetooth devices, since any interference on any particular frequency will last only 1/1600th of a second.

When two Bluetooth-capable devices come within range of one another, an automatic electronic exchange takes place to determine whether they have similar data to share or whether one needs to control the other. The user is not required to press a button or give a command—the electronic exchange happens automatically. Once the exchange has occurred, the devices—whether they're part of a computer system or a mobile phone, or another device—form a closed network. Bluetooth wireless systems create what is known as a personal-area network (PAN), or piconet, that will fill a standard classroom. Once a piconet is established, the paired devices randomly hop from frequency to frequency in unison so they stay in touch with one another and avoid other piconets that may be operating in a nearby classroom. Bluetooth technology is described in Wikipedia at http://en.wikipedia.org/wiki/Bluetooth. pp 1-13, which is incorporated by reference.

A host computer having a simple music jukebox software application that stores and manages a comprehensive organized directory of each student's specific audio voice commands in folders within an audio file library (similar to Apple's iTunes software for Mac and PC) may be used to program the handheld device. The commands can be recorded digitally with a simple microphone and stored in the library. The computer can also download other sets of commands from internet web stores or load them from a CD. The user can then plug in the USB dock connector and transfer audio clips to the hand held device. A user controlled syncronization process, using the USB dock connector, ensures that both the computer and the handheld device contain the same audio files in the same folders.

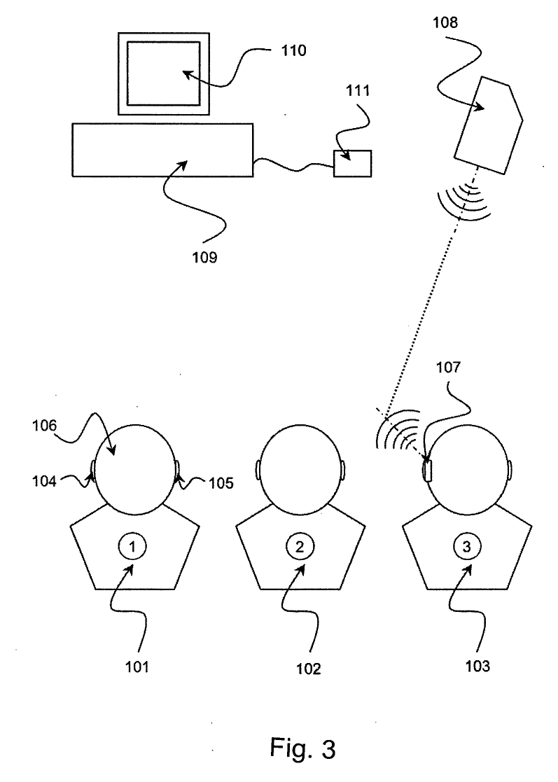

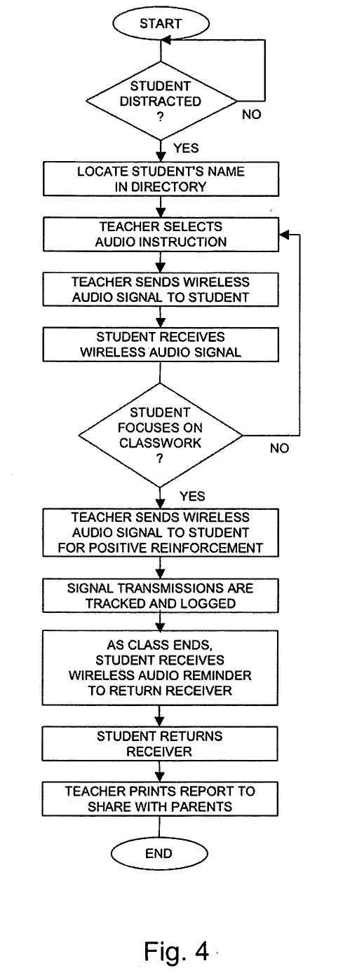

FIG. 3 is a schematic of an arrangement which shows the computer 109 and monitor 110 having a USB docking station 111 that is adapted to engage handheld device 108 for programming. Handheld device 108 communicates to students 101, 102 or 103 via a radio signal that is received by Bluetooth earpiece 107 on a student's left ear 104 or a students right ear 105 on students head 106. The behind the ear Bluetooth receiver 107 FIG. 4 is a flow chart of the steps that may be used in the operation of this embodiment of the invention.

A further description of how the system may be employed is as follows: A teacher with a class of 27 students wherein three students have been diagnosed with ADHD and/or other mental disorders are provided with the small device described above that fits in the palm of her hand. If she notices that one of the previously mentioned children is becoming unfocused she uses a scroll wheel on the device to scroll to that child's name, his or her picture is displayed on the LCD screen. With one click she brings up a menu of digitally stored audio commands (mp3 files). She clicks on one of the commands. The student hears, “Johnny, please focus on the class work now”. Hearing this, Johnny realizes he is being a little disruptive, so he turns his attention to the front of the class and is a willing participant. Mrs. Hubbard then scrolls to one of a number of positive reinforcement messages and presses the select button. Johnny hears “Good Job Johnny!” Automatically the entire interchange is recorded statistically for a future progress report that can be printed out by either connecting the device directly to a printer or by downloading to a computer for printing the report at a later time.

At the end of class, the teacher's handheld uses an internal timer to alert all the students using ear buds to return them.

We claim:

1. A system for reminding an inattentive child to return to an ongoing educational task, said system comprising a transmitter means that is adapted to transmit a signal to one or more individually tuned receivers that are adapted to be worn by a student, each of said receivers being adapted to receive said signal and in turn generate a further signal that activates a notification means that silently reminds the student to focus attention on the task at hand.

2. A system for reminding an inattentive child to return to an ongoing educational task as defined in claim 1 which comprises a transmitter that is adapted to transmit a plurality of different signals to receivers that are tuned to only receive a single frequency.

3. A system for reminding an inattentive child to return to an ongoing educational task as defined in claim 1 wherein the receiver that is adapted to vibrate in response to a transmitted signal.

4. A system for reminding an inattentive child to return to an ongoing educational task as defined in claim 1 wherein the receiver is a wrist mounted receiver.

5. A system for reminding an inattentive child to return to an ongoing educational task as defined in claim 1 wherein the system includes a memory means that records the number of signals sent to an individual student.

6. A system for reminding an inattentive child to return to an ongoing educational task as defined in claim 5 wherein the system includes a memory means that records the time interval between the sending of each signal to an individual student.

7. A system for reminding an inattentive child to return to an ongoing educational task as defined in claim 5 wherein the system includes a memory means that records the time interval between signals and the number of signals that are sent to each individual student.

8. A system as defined in claim 7 which also includes a printer to prepare reports of the number and/or frequency of signals sent to each student.

9. A system as defined in claim 1 wherein the transmitter comprises a Bluetooth transmitter and a Bluetooth receiver.

10. a system as defined in claim 9 wherein the transmitter is provided with a microphone and is adapted to be directly programmed with commands.

11. A system as defined in claim 10 where the transmitter is provided with a USB dock connector for programming with a computer.

12. A system as defined in claim 10 wherein the transmitter is also provided with a digital camera and a display screen.

13. A system as defined in claim 10 wherein the Bluetooth receiver is adapted to be worn behind the ear.

14. A system as defined in claim 10 wherein the Bluetooth receiver is adapted to worn inside of the ear canal.
